(19) United States
(12) Patent Application Publication
(10) Pub. No.: US 2014/0333873 A1
(43) Pub. Date: Nov. 13, 2014

(54) DISPLAY DEVICE

(71) Applicant: SAMSUNG ELECTRONICS CO., LTD., Suwon-si (KR)

(72) Inventors: Sin Wook HYUNG, Busan (KR); Young Man AHN, Suwon-Si (KR); Kil Hong LEE, Seongnam-si (KR); Dae Hee LEE, Hwaseong-si (KR); Hyeong Sik CHOI, Hwaseong-si (KR)

(73) Assignee: SAMSUNG ELECTRONICS CO., LTD., Suwon-si (KR)

(21) Appl. No.: 14/273,621

(22) Filed: May 9, 2014

(30) Foreign Application Priority Data
May 9, 2013 (KR) 10-2013-0052241

(51) Int. Cl. G02F 1/1335

(52) U.S. Cl. CPC G02F 1/133606
USPC 349/64; 362/97.1

(57) ABSTRACT

A display device including a display panel configured to display, a backlight unit configured to emit light toward the display panel, a pattern layer having a pattern formed to compensate for short-wavelength light among light emitted the backlight unit, and a diffusion plate configured to diffuse the compensated short-wavelength light and the light emitted from the backlight unit, so that the non-uniform color generated due to the color breakup is improved by use of blue ink having a bead shape that is disposed on the diffusion plate.

### CROSS-REFERENCE TO RELATED APPLICATIONS

This application claims the benefit of Korean Patent Application No. 10-2013-0052241, filed on May 9, 2013, in the Korean Intellectual Property Office, the disclosure of which is incorporated herein by reference.

### BACKGROUND

1. Field

Embodiments of the present disclosure relate to a display device for ensuring slimness while improving the image quality thereof.

2. Description of the Related Art

In general, a display device is a device configured to display visual image information in a two-dimensional or three-dimensional form.

In recent years, various types of Flat Panel Display devices having fewer restrictions with respect to installation space while also accomplishing thickness reduction and weight reduction, are being developed having still other benefits, such as easy representation of a large scale screen flatness, and a high quality. Such benefits are not easily provided in a Cathode Ray Tube.

Representative examples of the Flat Panel Display devices include a Liquid Crystal Display (LCD), an Electro-Luminescence Display (ELD), a Field Emission Display (FED), a Plasma Display Panel (PDP), a Thin Film Transistor-LCD (TFT-LCD), and a flexible display.

Among these, the LCD is increasingly being used in various areas, such as a slim television, a slim monitor, and a slim portable display due to the low weight, low power consumption, and a thin thickness of the LCD display.

The LCD displays an image using light emitted from a backlight unit.

Here, the backlight unit is divided into a direct-type backlight unit having a light emitting device arranged at a lower surface of a liquid crystal panel to emit light from the light emitting device, and an edge-lit type light backlight unit having a light emitting device installed at one end of a light guide panel installed at a lower side of a liquid crystal panel to emit light from the light emitting device.

In order to achieve slimness of the LCD, the thickness of a backlight unit is reduced, and as the distance between a light source and a diffusion plate is smaller, there is a limitation on representing an image of the light source on a plane using the diffusion plate, and a portion at which the light source is located has a relatively greater brightness with respect to the rest of the display and thus a bright line will be visible. Here, an image such as an outline of the light source will be visible even with the naked eye.

In addition, if the distance between the light source and the diffusion plate is smaller, a bright line of the light source is visible when viewed from a lateral side. In other words, the brightness uniformity viewed from a front is seen to be different from the brightness uniformity viewed from a lateral side.

In addition, if the thickness of the backlight unit is reduced, the light output from the LED, serving as a light source, is not sufficiently mixed, and thus the color breakup and thus Mura, such as a lack of uniformity, may occur. Accordingly, there is a limitation on attaining slimness of the backlight unit.

### SUMMARY

Therefore, it is an aspect of the present disclosure to provide a display device including blue bead ink that is disposed between a diffusion plate and a backlight unit.

Additional aspects of the disclosure will be set forth in part in the description which follows and, in part, will be obvious from the description, or may be learned by practice of the disclosure.

In accordance with one aspect of the present disclosure, a display device includes a display panel, a backlight unit, a pattern layer, and a diffusion plate. The display panel may be configured to display. The backlight unit may be configured to emit light toward the display panel. The pattern layer may have a pattern formed to compensate for short-wavelength light among light emitted the backlight unit. The diffusion plate may be configured to diffuse the compensated short-wavelength light and the light emitted from the backlight unit.

The pattern may have a color corresponding to the short-wavelength light, and may allow the short-wavelength light to pass therethrough.

The pattern may be a pattern having a blue color.

The pattern having the blue color may be a pattern formed of bead-shaped material having a blue color.

The pattern may be formed in a printing method.

The backlight unit may include a light source. A position of the pattern of the pattern layer may face a position of the light source.

The pattern may have an area larger than an area of the light source.

The pattern of the pattern layer may be provided to have a larger area if a distance between the backlight unit and the diffusion plate is smaller.

The pattern may include mixture material having first material mixed with second material that is bead-shaped material of a blue color.

The pattern may include a first pattern formed on a surrounding area around the light source, and a second pattern formed on a region except for the surrounding area. The first pattern may include first mixture material, and the second pattern may include second mixture material having a smaller percentage of second material when compared to the first mixture material.

The first pattern may be a pattern formed by primarily printing the first mixture material. The second pattern may be a pattern formed by secondarily printing the second mixture material.

The pattern layer may be located between the diffusion plate and the backlight unit, while making contact with the diffusion plate.

In accordance with another aspect of the present disclosure, a display device having a backlight unit emitting light toward a display panel includes a diffusion plate. The diffusion plate may be disposed between the display panel and the backlight unit. The diffusion plate may include a diffusion layer and a pattern layer. The diffusion layer may be configured to diffuse light emitted from the backlight unit. The pattern layer may be provided with a pattern partially formed on the diffusion layer, to compensate for short-wavelength light.

The pattern may include mixture material having first material mixed with second material that has a color different from the first material.

A mixture ratio of the first material and the second material may be determined based on a distance between the backlight unit and a light source.

The first material may be material that is semi-transparent material having a white color. The second material may be material having a blue color.

The second material may include bead shaped material.

The pattern may be a pattern having different mixture materials printed at different regions.

The pattern may include a first pattern formed by primarily printing first mixture material, and a second pattern formed by secondarily printing second mixture material having a smaller percentage of a second material when compared to the first mixture material.

The first pattern may be a pattern printed at a position facing a light source of the backlight unit, and the second pattern may be a pattern printed on a region except for the first pattern.

The light source of the backlight unit may include a plurality of light emitting diodes (LED).

The pattern of the pattern layer may be a pattern formed by irregularly coating blue color ink.

The diffusion layer of the diffusion plate may mix the light emitted from the backlight unit and the light passing through the pattern layer and may diffuse the mixed light.

The pattern layer may increase transmittance of short-wavelength light among the light emitted from the backlight unit.

In accordance with another aspect of the present disclosure, a display device includes a backlight unit to emit light, a pattern layer comprising a first pattern configured to increase transmittance of light in a first wavelength range to be greater than transmittance of light in a second wavelength range, and a second pattern configured to increase transmittance of light in the second wavelength range to be greater than transmittance of light in the first wavelength range, and a diffusion plate to diffuse the light emitted from the backlight unit and transmitted through the patter layer.

In accordance with another aspect of the present disclosure a method of compensating for short-wavelength light among light emitted by a backlight unit of a display device to a diffusion plate is described. The method includes disposing a mask at one side of the diffusion plate and providing a first pattern using a first mixture material and a second pattern using a second mixture material on the mask, wherein the first mixture material is configured to increase transmittance of light in a first wavelength range to be greater than transmittance of light in a second wavelength range in the first pattern, and the second mixture material is configured to increase transmittance of light in the second wavelength range to be greater than transmittance of light in the first wavelength range in the second pattern.

As is apparent from the above description, the non-uniform color generated due to the color breakup is improved by use of blue ink having a bead shape that is disposed on the diffusion plate.

Accordingly, the backlight unit removes a representation of the light source in the backlight unit, and the visibility can be ensured.

In addition, the distance between the light source and the diffusion plate is reduced to the minimum while providing a slimness of the display device, thereby providing competitiveness over other manufacturer's display devices.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a drawing illustrating an example of a display device in accordance with an embodiment of the present disclosure;

FIG. 2 is an exploded perspective view illustrating a body of the display device in accordance with an embodiment of the present disclosure;

FIG. 3 is a cross sectional view illustrating a display panel provided in the display device in accordance with an embodiment of the present disclosure;

FIG. 4 is a drawing illustrating an example of a backlight unit, a diffusion plate and a pattern layer that are provided in the display device in accordance with an embodiment of the present disclosure;

FIGS. 5A, 5B, 6, 7A, 7B and 8 are drawings illustrating an example of forming a pattern layer disposed between the backlight unit and the diffusion plate of the display device in accordance with an embodiment of the present disclosure;

FIG. 9 is a drawing illustrating an example of light transmission of the display device in accordance with an embodiment of the present disclosure;

FIG. 10 is a graph showing a by-wavelength light transmittance in accordance with a conventional technology and a by-wavelength light transmittance in accordance with an embodiment of the present disclosure; and

FIG. 11 is a graph showing horizontal y-color coordinates in accordance with a conventional technology and horizontal y-color coordinates in accordance with an embodiment of the present disclosure.

### DETAILED DESCRIPTION

Reference will now be made in detail to the embodiments of the present disclosure, examples of which are illustrated in the accompanying drawings, wherein like reference numerals refer to like elements throughout.

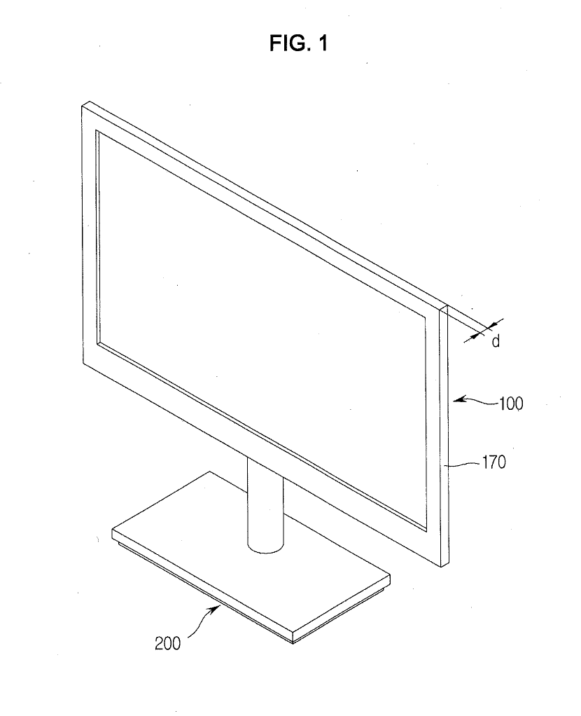

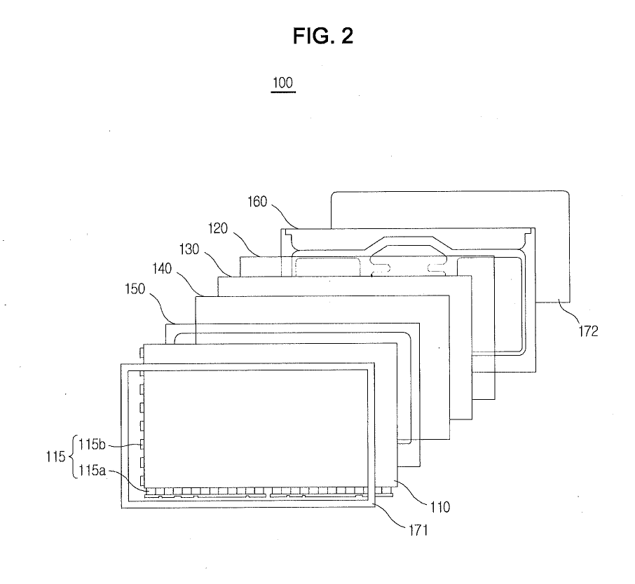

FIG. 1 is a drawing illustrating an example of a display device in accordance with an embodiment of the present disclosure, and FIG. 2 is an exploded perspective view illustrating a body of the display device in accordance with an embodiment of the present disclosure.

A display device 1 is a device configured to display an image, for example, a television, a monitor and a display device of a mobile communication terminal.

Referring to FIG. 1, the display device 100 may display an image and output sound. The sound may be output through an external device.

The display device 100 may be supported by a stand 200 mounted at a lower end thereof or alternatively may be installed on a wall with a bracket.

The display device 100 may include a backlight unit 120 and a diffusion plate 130. The display device 100 may be provided in a slim structure having an overall thickness (d) that is reduced by reducing the distance between the backlight unit 120 and the diffusion plate 130, for example, a liquid crystal display device (LCD).

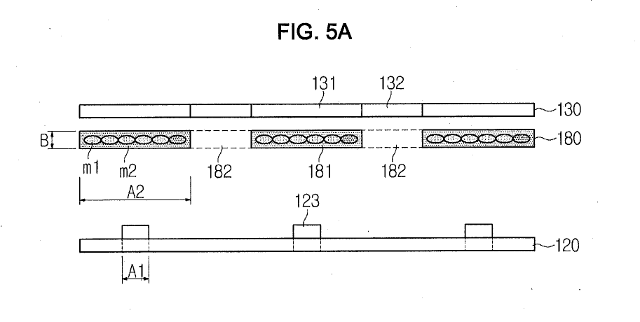

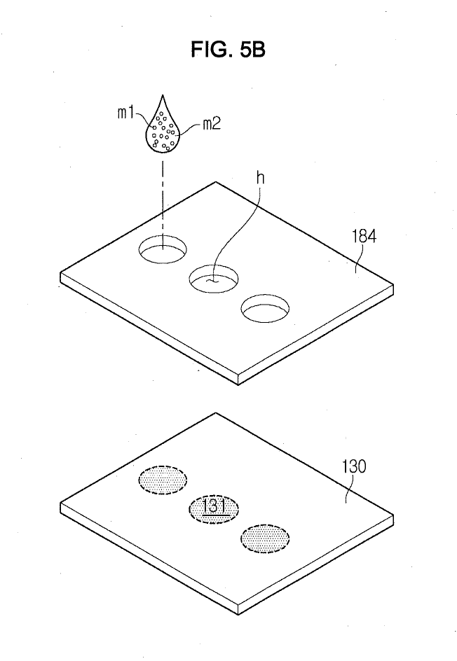

Referring to FIG. 2, the display device 100 may include a display panel 110, the backlight unit 120, the diffusion plate 130, a protection sheet 140, a support member 150, a chassis 160, a housing 170 (171 and 172), and a pattern layer 180, shown in FIG. 5A for example.

The display panel 110 is a panel configured to display image information, such as a text, a number, a photograph, a website, or an icon, by adjusting transmittance of light passing through a liquid crystal layer. The transmittance of light passing through the liquid crystal layer may be adjusted by the intensity of voltage applied.

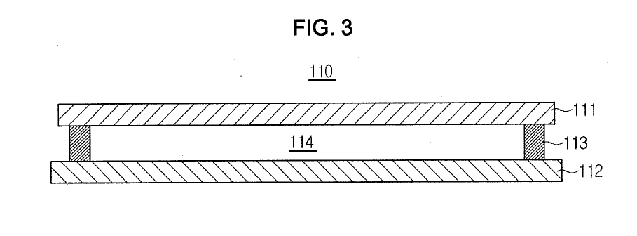

Referring to FIG. 3, the display panel 110 may include a color filter array panel 111, a thin film transistor (TFT) array panel 112 and a sealant 113. Each of the color filter panel and the TFT panel is formed of glass.

The color filter array panel 111 may include a red color filter, a green color filter and a blue color filter that are formed at regions corresponding to respective pixel electrodes of the TFT panel 112. In addition, a common electrode made of transparent conductive material, such as an Indium Tin Oxide (ITO) or an Indium Zinc Oxide (IZO), is formed on the color filter array panel 111.

The TFT panel 112 of the display panel 110 is disposed in a way that the TFT panel 112 is spaced apart from the color filter array panel 111, and includes a plurality of gate lines, a plurality of data lines and a plurality of pixel electrodes.

The gate lines are disposed in a row direction to transmit a gate signal, and the data lines are disposed in a column direction to transmit a data signal, and the pixel electrode is connected to the gate line and the data line while including a switching device and a sustain capacitor.

Here, the switching device is formed at an intersection of the gate line and the data line, and the sustain capacitor has one terminal connected to an output terminal of the switching device.

The other terminal of the sustain capacitor is connected to a common voltage or the gate line.

The display panel 110 may further include a liquid crystal layer 114 disposed between the color filter array panel 111 and the TFT panel 112. The liquid crystal panel 114 includes sealing material and liquid crystals accommodated in the sealing material.

The liquid crystal layer 114 has an alignment direction that changes according to a voltage applied from the outside, thereby adjusting transmittance of light passing through the liquid crystal layer 114.

Meanwhile, the color filter array panel 111, the TFT panel 112 and the liquid crystal layer 114 of the display panel 110 form a liquid crystal capacitor in cooperation with one another, and the liquid crystal capacitor formed as such is connected to the output terminal of the switching device of the pixel electrode and to a common voltage or a reference voltage.

The sealant 113 is formed at peripheries of the color filter array panel 111 and the TFT panel 112 of the display panel 110, and serves to couple the color filter array panel 111 to the TFT panel 112. The sealant 113 enables the display panel 110 to maintain its shape.

The display panel 110 may further include an image driver 115.

The image driver 115 may include, for example, a first driver 115a driving an X-electrode, and a gate driver 115b driving a Y-electrode.

The X-electrode is a source electrode and the Y-electrode is a gate electrode.

The first driver 115a and the second driver 115b are connected to a driving module (not shown).

The first driver 115a selects a gray scale voltage for each data line based on image data and transmits the selected gray scale voltage to the liquid crystal through the data line.

The second driver 115b transmits an ON/OFF signal based on the image data to a thin film transistor (TFT), that is, a switching device, through a scan line, to turn on/off the TFT.

That is, if a voltage corresponding to each color value is supplied by the first driver 115a, the second driver 115b receives the voltage and connects the voltage to a corresponding pixel.

The source electrode of the TFT is connected to the data line, the gate electrode is connected to the scan line, and a drain electrode of the TFT is connected to the pixel electrode. Such a TFT, when a scan signal is supplied to a scan line, is turned on and supplies a data signal supplied from a data line to the pixel electrode.

A predetermined voltage is applied to the common electrode, and thus an electric field is formed between the common electrode and the pixel electrode. Due to the electric field, an alignment angle of the liquid crystal of the liquid crystal panel is changed, and based on the changed alignment angle, the light transmittance is changed such that a desired image is displayed.

The driving module (not shown) provides a gate control signal, a data control signal, and a gate drive signal and a data drive signal based on a data signal that is related to a data control signal and a data signal to the gate line and the data line formed on the TFT panel 112, thereby implementing a desired image on the display panel 110. This will be described in detail.

The backlight unit 120 is a light source device emitting light from a rear side of the display panel 110, and may be classified as a Direct LED light source device.

That is, since the display panel 110 does not emit light from the liquid crystal, an image is represented by adjusting the transmittance and color of light emitted from the backlight unit 120.

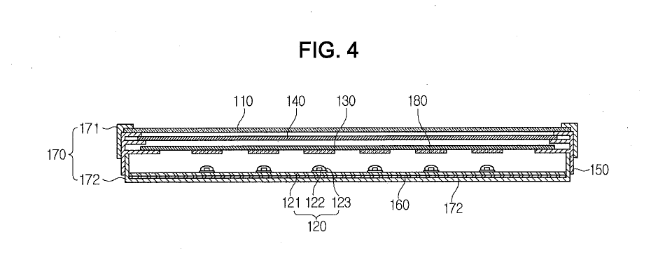

Referring to FIG. 4, the backlight unit 120 may include, for example, a base 121, an optical driver 122 fixedly mounted on the base 121, and a plurality of light sources 123 emitting light by use of power supplied from the optical driver 122.

Here, the light source 123 is a light emitting diode (LED) generating light at a high efficiency and with low power consumption. The optical driver 122 is configured to supply and block the power supplied to the LED or to adjust the magnitude of power being supplied to the LED, and may be implemented as a printed circuit board (PCB) having a plurality of LEDS electrically mounted thereon.

The diffusion plate 130 is a semi-transparent panel that is located between the display panel 110 and the backlight unit 120, to diffuse light provided from the backlight unit 120 to provide a plane of the diffusion plate 130 such that overall color and brightness are Uniformly represented. The diffusion plate 130 enhances the brightness of light emitted from the backlight unit 120 and supplies the brightness enhanced light to the display panel 110.

That is, the diffusion plate 130 expands the output range of the light of the LED of the backlight unit 120 and maintains the overall brightness to be uniform.

The display device may further include the protection sheet 140 to protect the display panel 110 from the outside impact.

The protection sheet 140 may be disposed between the display panel 110 and the diffusion plate 130 and may further include glass and a filter. The glass protects the filter from being broken by external impact, and the filter includes an optical characteristic film, an Electro Magnetic Interference (EMI) shielding film and an ultraviolet shielding film.

The optical characteristic film reduces the brightness of red (R) and green (G) among the light incident onto the display panel 110 while increasing the brightness of blue (B), thereby enhancing the optical characteristics. The EMI shielding film is configured to shield electromagnetic waves to prevent electromagnetic waves introduced to the display panel from being discharged outside.

In addition, the ultraviolet shielding film is configured to shield ultraviolet radiation emitted from the display panel to prevent a predetermined level or more of ultraviolet radiation from being emitted to the outside, so that signals transmitted by use of ultraviolet, for example, signals of a remote controller, are transmitted normally.

The support member 150 supports the display panel 110, the diffusion plate 130, the protection sheet 140 and the light source 160, which are each disposed between a bezel 171 and a cover 172.

In addition, the support member 150 is configured to maintain the distance between the display panel 110 and the protection sheet 140, the distance between the diffusion plate 130 and the protection sheet 140, and the distance between the diffusion plate 130 and the backlight unit 120.

The chassis 160 is a panel connecting various components required to display an image and output sound, and has various printed circuit boards and various input/output devices mounted thereon.

The chassis 160 is formed of metal having superior thermal resistance and strength.

The chassis 160 has the driving module (not shown) disposed thereon to drive the display panel 110 and the backlight unit 120. The driving module (not shown) will be described later.

The housing 170 includes the bezel 171 and the cover 172.

The bezel 171 is configured to fix the display panel 110 that is supported by the support member 150, and is detachably coupled to the support member 150 or the cover 172.

The bezel 171 forms an accommodation space while being coupled to the cover 172, and the display panel 110, the backlight unit 120, the diffusion plate 130, the protection sheet 140 and the chassis 160 are disposed in the accommodation space.

The display device 100 further includes the pattern layer 180.

The pattern layer 180 is located between the backlight unit 120 and the diffusion plate 130, and includes a pattern configured to adjust the amount of light according to wavelengths introduced to the diffusion plate 130.

Here, the pattern of the pattern layer 180 may be formed based on the positions and the arrangement shape of the light sources 123 of the backlight unit 120. The pattern of the pattern layer 180 may be located at a position facing the light source 123 of the backlight unit 120.

That is, in a case in which the light source 123 of the backlight unit 120 is provided as a plurality of light sources, the patterns need to be formed at positions facing the plurality of light sources, respectively, and thus the pattern layer 180 has the same shape as an arrangement shape of the plurality of light sources.

The pattern layer 180 may be separately formed from the diffusion plate 130 or may be integrally formed with the diffusion plate 130.

When the pattern layer 180 is integrally formed with the diffusion plate 130, the pattern layer 180 is formed on the diffusion plate 130 through various methods, such as an application, a printing, a coating and a bonding. This will be described with reference to FIGS. 5A, 5B, 6, 7A, 7B and 8.

FIGS. 5A and 5B illustrate an example of the display device including a pattern layer integrally formed with the diffusion plate 130.

Referring to FIG. 5A, the diffusion plate 130 is composed of a diffusion layer having a plate shape, and the diffusion layer includes a first region 131 adjacent to a first pattern 181 of the patter layer 180, and a second region 132 adjacent to a second pattern 182 of the pattern layer 180.

The first region 131 of the diffusion plate 130 is a region to which light in a first wavelength range is introduced and the second region 132 is a region to which light in a second wavelength range is introduced, and the diffusion plate 130 is configured to mix light in the first wavelength range with light the second wavelength range to distribute the mixed light to suit the plane of the diffusion plate 130.

To be more specific, the first region 131 is a region to which light in the first wavelength range is introduced more than light in the second wavelength range, and the second region 132 is a region to which light in the second wavelength range is introduced more than light in the first wavelength range. Accordingly, a similar amount of light at each wavelength is introduced to the inside of the diffusion layer 130, and the light at each wavelength introduced to the inside is mixed and diffused.

That is, by forming the first pattern on the diffusion plate 130, a larger amount of light in the first wavelength range is introduced to the diffusion plate 130.

The pattern layer 180 includes the first pattern 181 increasing the transmittance of light in the first wavelength range to be greater than the transmittance of light in the second wavelength range, and the second pattern 182 increasing the transmittance of light in the second wavelength range to be greater than the transmittance of light in the first wavelength range.

The first wavelength range is a relatively short-wavelength range, and the second wavelength range is a range other than the short-wavelength range. The color of light belonging to the short-wavelength range corresponds to a blue color series.

The first pattern 181 is a pattern formed of a first mixture material having first material m1 that is semi-transparent and of a white color mixed with a second material m2 formed of a bead-shaped material having a blue color. The second pattern 182 is provided as an empty area except for the first pattern 181.

In addition, the first pattern 181 may be formed of bead-shaped material having a blue color.

As the first pattern 181 is formed using blue ink having a bead shape, the surface area for reflecting and scattering the short-wavelength light is enlarged, thereby enhancing the efficiency in compensating for the short-wavelength light.

In addition, the first pattern 181 is formed on the first region 131 of the diffusion plate 130, and the second pattern 182 is formed on the second region 132, that is, the remaining region of the diffusion plate 130. The first pattern 181 may be formed using a printing method.

The first pattern 181 is formed at a position corresponding to a position of the light source 123 of the backlight unit 120, and has an area A2 larger than an area A1 of the light source 123.

The area A2 of the first pattern 181 may be about five to six times larger than the area A1 of the light source 123, and may have a thickness B of about 5 um to 20 um.

Hereinafter, a method of forming the pattern layer 180 on the diffusion plate 130 will be described with reference to FIG. 5B.

First, the diffusion plate 130 that is semi-transparent is disposed, and a mask 184 is disposed at one side of the diffusion plate 130.

Here, the mask 184 includes a plurality of holes h, and a hole h of the plurality of holes h is provided at a position corresponding to the light source 123 of the backlight unit 120, and corresponding to a location in which the first pattern 181 is formed.

Thereafter, in a state in which the mask 184 is disposed at the one side of the diffusion plate 130, mixture material m1+m2 having first material and second material mixed with each other is printed on the diffusion plate 130, and then the mask 184 is separated from the diffusion plate 130.

Through such, the first pattern 181 formed of the mixture material m1+m2 is formed on the first region 131 of the diffusion plate 130.

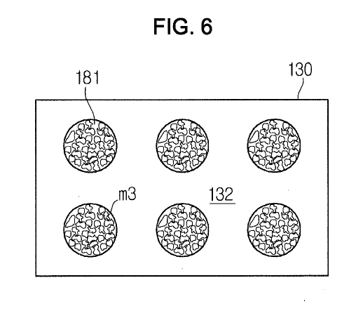

FIG. 6 is a drawing illustrating another example of the display device including the pattern layer integrally formed with the diffusion plate 130.

Referring to FIG. 6, the diffusion plate 130 is composed of a diffusion layer having a plate shape, and the diffusion layer may include the first region 131 adjacent to the first pattern 181 of the pattern layer 180 and the second region 132 adjacent to a remaining region of the pattern layer 180 other than the first pattern 181.

The pattern layer 180 includes the first pattern 181 increasing transmittance of light in the first wavelength range, that is, the short-wavelength range.

Here, the first pattern 181 is a pattern formed by irregularly forming blue color ink m3 on the first region 131 of the diffusion plate 130, and the pattern is formed at a position corresponding to the position of the light source of the backlight unit.

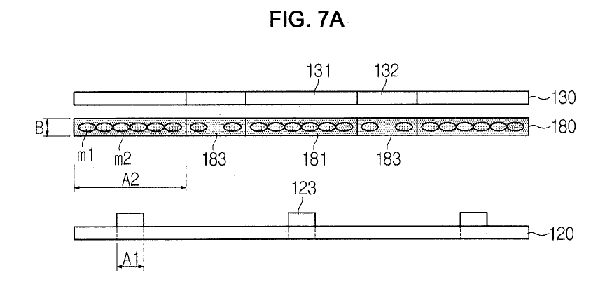

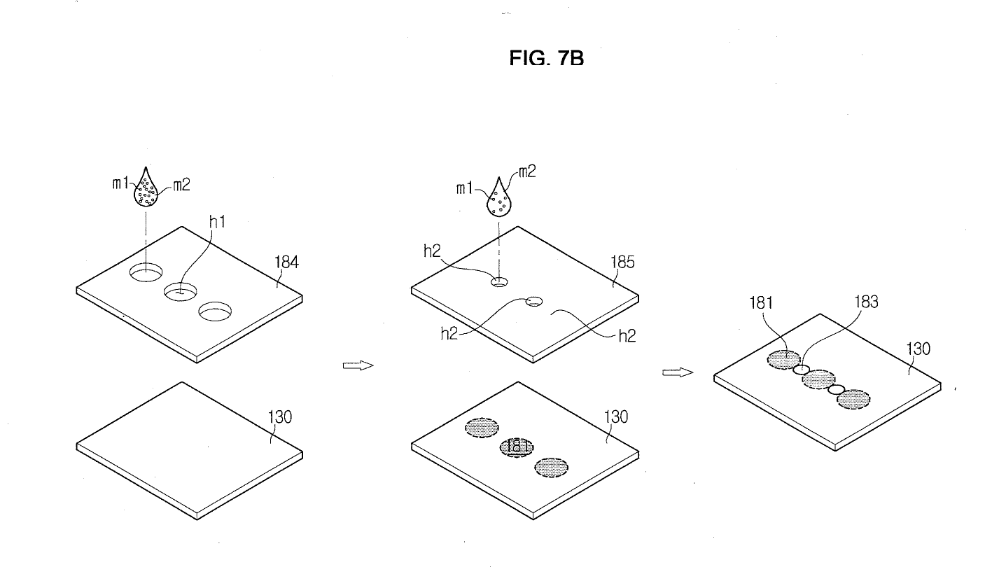

FIGS. 7A and 7B are drawings illustrating another example of the display device including a pattern layer integrally formed with the diffusion plate 130.

Referring to FIG. 7A, the diffusion plate 130 is composed of a diffusion layer having a plate shape, and the diffusion layer includes the first region 131 adjacent to the first pattern 181 of the patter layer 180, and the second region 132 adjacent to a second pattern 183 of the pattern layer 180. In alternative embodiments the first region 131 may oppose or face the first pattern 181 of the patter layer 180, and the second region 132 may oppose or face the second pattern 183 of the pattern layer 180.

The pattern layer 180 includes the first pattern 181 and the second pattern 183.

Here, the second pattern 183 is a pattern corresponding to a remaining region of the pattern layer 180 except for the first pattern 181. In addition, the second pattern 183 may be a pattern corresponding to a portion adjacent to the first pattern 181 in the remaining region of the pattern layer 180 except for the first pattern 181.

The first pattern 181 is a pattern formed of first mixture material having a first material m1 that is semi-transparent and of a white color mixed with a second material m2 formed of a bead-shaped material having a blue color. The second pattern 183 is a pattern formed of a second mixture material that has a smaller percentage of the second material m2 in comparison to the first mixture material.

That is, the first pattern 181 is a pattern printed using the first mixture material and the second pattern 183 is a pattern printed using the second mixture material.

The first pattern 181 is formed at a position corresponding to a position of the light source 123 of the backlight unit and has an area A2 larger than an area of A1 of the light source 123.

The area A2 of the first pattern 181 may be about five to six times larger than the area A1 of the light source 123, and may have a thickness B of about 5 um to 20 um.

Hereinafter, a method of forming the first pattern 181 and the second pattern 183 of the pattern layer 180 on the diffusion plate 130 will be described with reference to FIG. 7B.

First, the diffusion plate 130 that is semi-transparent is disposed, and a first mask 184 is disposed at one side of the diffusion plate 130.

Here, the first mask 184 includes a plurality of first holes h1, and the first hole h1 of the plurality of first holes h1 is a hole that is provided at a position corresponding to the light source 123 of the backlight unit 120 and in which the first pattern 181 is formed.

Thereafter, in a state in which the first mask 184 is disposed at the one side of the diffusion plate 130, the first mixture material m1+m2 composed of first material and second material mixed with each other is printed on the diffusion plate 130, and then the first mask 184 is separated from the diffusion plate 130.

Through such, the first pattern 181 formed of the first mixture material m1+m2 is formed on the first region 131 of the diffusion plate 130.

Thereafter, a second mask 185 is disposed at the one side of the diffusion plate 130.

Here, the second mask 185 includes a plurality of second holes h2, and the hole h2 of the plurality of second holes h2 is a hole that is formed at a position except for the position of the first hole h1 and in which the second pattern 182 is formed.

Thereafter, in a state in which the second mask 185 is disposed at the one side of the diffusion plate 130, the second mixture material m1+m2 having a smaller percentage of the second material when compared to the first mixture material is printed on the diffusion plate 130, and then the second mask 185 is separated from the diffusion plate 130.

Through such, the second pattern 183 formed of the second mixture material m1+m2 is formed on the second region 132 of the diffusion plate 130.

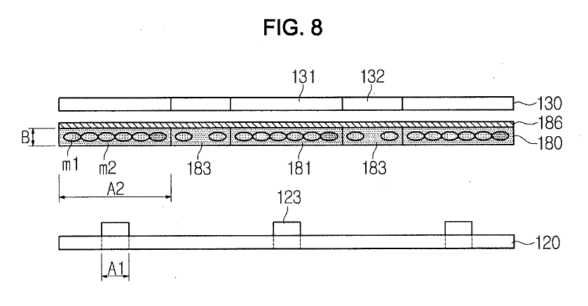

FIG. 8 is a drawing illustrating an example of a display device including a pattern layer that is separately formed from the diffusion plate 130.

The pattern layer 180 is disposed on the diffusion plate 130 while coming into close contact with or while being spaced apart from the diffusion plate 130.

The diffusion plate 130 includes the first region 131 adjacent to the first pattern 181 of the patter layer 180, and the second region 132 adjacent to the second pattern 183 of the pattern layer 180.

The first region 131 of the diffusion plate 130 is a region to which light in a first wavelength range is introduced and the second region 132 is a region to which light in a second wavelength range is introduced, and the diffusion plate 130 is configured to mix light in the first wavelength range with light the second wavelength range to distribute the mixed light to suit a plane of the diffusion plate 130.

The pattern layer 180 includes the first pattern 181 and the second pattern 183.

The patter layer 180 may further include a sheet 186 on which the first pattern 181 and the second pattern 183 are disposed.

The first pattern 181 is a pattern formed of first mixture material having a first material m1 that is semi-transparent and of a white color mixed with a second material m2 formed of a bead-shaped material having a blue color. The second pattern 183 is a pattern formed of a second mixture material that has a smaller percentage of the second material m2 in comparison to the first mixture material.

That is, the first pattern 181 is a pattern printed using the first mixture material and the second pattern 183 is a pattern printed using the second mixture material.

The first pattern 181 is formed at a position corresponding to a position of the light source 123 of the backlight unit 120 and has an area A2 larger than an area A1 of the light source 123.

The area A2 of the first pattern 181 may be about five to six times larger than the area A1 of the light source 123, and may have a thickness B of about 5 um to 20 um.

The first pattern 181 increases the transmittance of light in the first wavelength range among the light emitted from the backlight unit 120 that is a short-wavelength range, while reducing the transmittance of light in the second wavelength range that is the remaining wavelength range except for the short-wavelength range.

That is, the first pattern 181 of the pattern layer 180 allows a larger amount of light in the first wavelength range to pass therethrough while allowing a smaller amount of light in the second wavelength range to pass therethrough.

Meanwhile, the second pattern 183 of the pattern layer 180 allows a larger amount of light in the second wavelength range to pass therethrough while allowing a smaller amount of light in the first wavelength range to pass therethrough.

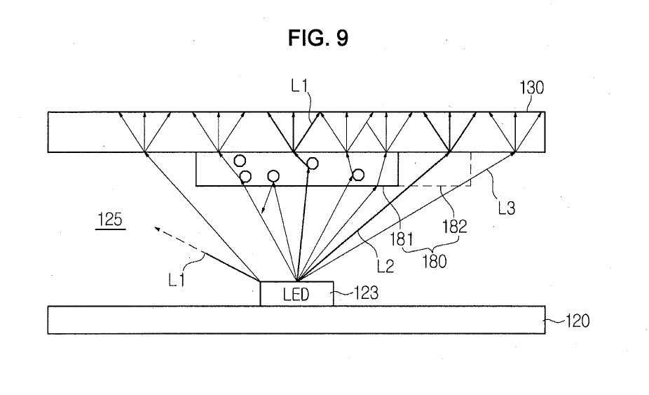

This will be described with reference to FIG. 9.

The backlight unit 120 is disposed while being spaced apart from the diffusion plate 130. That is, a diffusion space 125 is formed between the backlight unit 120 and the diffusion plate 130 such that the light emitted from the light source 123 of the backlight unit is primarily diffused therein.

The light emitted from the light source 123 of the backlight unit 120 includes light in various wavelengths, and loss of most of light L1 in the short-wavelength range occurs in the diffusion space 125, and light L2 and light L3 in the remaining wavelength ranges that pass by the diffusion space 125 are introduced to the diffusion plate 130.

That is, a series of red color light having a long wavelength among the light emitted from the light source 123 of the backlight unit 120 is diffused to the diffusion plate 130, but blue series light in a short wavelength range having high scattering characteristic is scattered without being diffused to the diffusion plate 130.

The light in the diffusion space 125 passing through the pattern layer 180 is introduced to the diffusion plate 130, and the light introduced to the diffusion plate 130, while being mixed with each other and diffused, passes through the diffusion plate 130. The light passing through the diffusion plate 130 is introduced to the display panel 110.

Hereinafter, a process of the light in the diffusion space 125 being introduced to the diffusion plate 130 after passing through the pattern layer 180 will be described.

Light introduced to the first pattern 181 of the pattern layer 180 among the light in the diffusion space 125 is reflected and scattered by the bead shape material having a blue color, and then emitted toward the first region 131 of the diffusion plate 130. In this case, the light L1 introduced to the first pattern 181 is introduced to the diffusion plate 130 while having short-wavelength range light compensated by the blue color material.

That is, the first pattern 181, which is formed of material having a blue color, increases the transmission of light among light emitted from the light source of the backlight unit 120 in the first wavelength range that is a short-wavelength range, and reduces the transmission of light in the remaining wavelength range except for the short-wavelength range.

Accordingly, the first pattern 181 allows a larger amount of light in the first wavelength range to pass therethrough while allowing a smaller amount of light in the second wavelength range to pass therethrough.

As for light among the light in the diffusion space 125 that is introduced to the second pattern 182 of the pattern layer 180, light at a short-wavelength range experiences a light loss, and light in the remaining wavelength ranges L2 and L3 is emitted to the second region of the diffusion plate 130. That is, the second pattern 182 emits the light in the second wavelength range more than the light in the first wavelength range.

The light passing through the second pattern 182 represents light, in which the short-wavelength range light experiences more light loss, thereby having a relatively yellow color. The light passing through the first pattern 181 represents light having the short-wavelength range light compensated and thus has more of blue color.

The light L1 having the short-wavelength light compensated by the first pattern 181 of the pattern layer 180 and the light L2 and the light L3 passing through the second pattern 182 are introduced to the diffusion plate 130.

The diffusion plate 130 receives more of short-wavelength range light through the first pattern 181, and receives more of remaining wavelength range light through the second pattern 182 when compared to the short-wavelength range light.

Such a diffusion plate 130 mixes the first wavelength range light introduced to the first region 131 with the second wavelength range light introduced to the second region 132 while diffusing the mixed light, and emits the diffused light to the display panel 110.

A front end of the LED is prevented from yellowing due to a color breakup caused by slimness of the direct-type LED backlight unit.

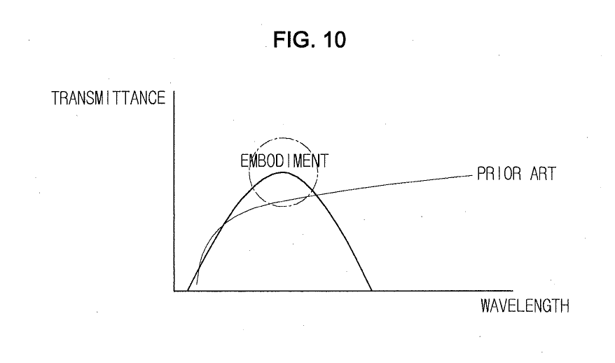

FIG. 10 is a graph showing a by-wavelength light transmittance in a case in which the first pattern of the pattern layer is printed using a bead-shaped material having a blue color.

As the first pattern of the pattern layer is formed at a position facing the light source (LED: 123) of the backlight unit, the transmission of short-wavelength range light of the light source is increased.

As described, by increasing the transmission of the short-wavelength light, the color breakup is prevented, and the color is uniformly represented on the display panel.

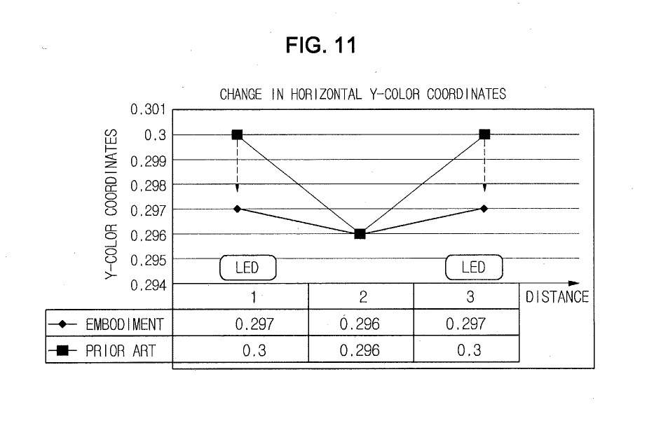

FIG. 11 is a graph showing horizontal y-color coordinates in a case in which the first pattern of the pattern layer is printed using a bead-shaped material having a blue color.

In a case in which the first pattern of the pattern layer is printed using a bead-shaped material having a blue color, y-color coordinates at a position facing the light source (LED) is improved by 3/1000 when compared to the conventional technology having no pattern.

In addition, in the conventional technology, the difference between a y-color coordinate value at a position facing the light source (LED) and a y-color coordinate value at a region between two light sources is greater compared to that described in the present disclosure. That is, in accordance with the present disclosure, a y-color coordinate value at a position facing a light source is almost same as a y-color coordinate value at a region between light sources.

In addition, the y-color coordinate value may be adjusted depending on the density of blue beads forming the first pattern.

Although a few embodiments of the present disclosure have been shown and described, it would be appreciated by those skilled in the art that changes may be made in these embodiments without departing from the principles and spirit of the disclosure, the scope of which is defined in the claims and their equivalents.

What is claimed is:

1. A display device comprising:
a display panel to display an image;
a backlight unit to emit light toward the display panel;
a pattern layer comprising a pattern formed to compensate for short-wavelength light among light emitted from the backlight unit; and
a diffusion plate to diffuse the compensated short-wavelength light and the light emitted from the backlight unit.

2. The display device of claim 1, wherein the pattern has a color corresponding to the short-wavelength light, and allows the short-wavelength light to pass therethrough.

3. The display device of claim 1, wherein the pattern is formed of a material having a blue color.

4. The display device of claim 1, wherein the pattern formed of a bead-shaped material having a blue color.

5. The display device of claim 4, wherein the pattern is formed with a printing method.

6. The display device of claim 1, wherein:
the backlight unit comprises a light source having a plurality of light emitting elements; and
a position of the pattern of the pattern layer faces a position of the plurality of light emitting elements.

7. The display device of claim 6, wherein the pattern has an area larger than an area of the light source.

8. The display device of claim 7, wherein the pattern of the pattern layer is provided to have a relatively larger area when a distance between the backlight unit and the diffusion plate is relatively small.

9. The display device of claim 6, wherein the pattern includes mixture material having a first material mixed with a second material that is a bead-shaped material of a blue color.

10. The display device of claim 9, wherein:
the pattern includes a first pattern formed on an area surrounding a corresponding area around the light source, and a second pattern formed on a region other than the area surrounding the corresponding area around the light source; and
the first pattern includes a first mixture material comprised of a first material mixed with a second material, and the second pattern includes second mixture material comprised of a smaller percentage of the second material when compared to the first mixture material.

11. The display device of claim 10, wherein:
the first pattern is a pattern formed by primarily printing the first mixture material; and
the second pattern is a pattern formed by secondarily printing the second mixture material.

12. The display device of claim 1, wherein the pattern layer is located between the diffusion plate and the backlight unit and contacts the diffusion plate.

13. A display device having a backlight unit emitting light toward a display panel, the display device comprising:
a diffusion plate disposed between the display panel and the backlight unit,
wherein the diffusion plate comprises:
a diffusion layer configured to diffuse light emitted from the backlight unit; and
a pattern layer provided with a pattern partially formed on the diffusion layer to compensate for short-wavelength light.

14. The display device of claim 13, wherein the pattern includes mixture material having a first material mixed with a second material that has a color different from the first material.

15. The display device of claim 14, wherein a mixture ratio of the first material and the second material is determined based on a distance between the backlight unit and a light source.

16. The display device of claim 14, wherein:
the first material is a semi-transparent material having a white color, and
the second material has a blue color.

17. The display device of claim 16, wherein the second material is comprised of a bead-shaped material.

18. The display device of claim 14, wherein the pattern is a pattern having different mixture materials printed at different regions of the pattern layer.

19. The display device of claim 18, wherein the pattern comprises a first pattern formed by primarily printing a first mixture material, and a second pattern formed by secondarily printing a second mixture material having a smaller percentage of the second material when compared to the first mixture material.

20. The display device of claim 19, wherein the first pattern is a pattern printed at a position facing a light source of the backlight unit, and the second pattern is a pattern printed on a region other than the first pattern.

21. The display device of claim 20, wherein the light source of the backlight unit includes a plurality of light emitting diodes (LED).

22. The display device of claim 13, wherein the pattern of the pattern layer is a pattern formed by irregularly coating blue color ink.

23. The display device of claim 13, wherein the diffusion layer of the diffusion plate mixes the light emitted from the backlight unit with the light passing through the pattern layer, and diffuses the mixed light.

24. The display device of claim 23, wherein the pattern layer increases transmittance of short-wavelength light among the light emitted from the backlight unit.

25. A display device comprising:
a backlight unit to emit light;
a pattern layer comprising a first pattern configured to increase transmittance of light in a first wavelength range to be greater than transmittance of light in a second wavelength range, and a second pattern configured to increase transmittance of light in the second wavelength range to be greater than transmittance of light in the first wavelength range; and
a diffusion plate to diffuse the light emitted from the backlight unit and transmitted through the patter layer.

26. A method of compensating for short-wavelength light among light emitted by a backlight unit of a display device to a diffusion plate, the method comprising:
disposing a mask at one side of the diffusion plate; and
providing a first pattern using a first mixture material and a second pattern using a second mixture material on the mask,
wherein the first mixture material is configured to increase transmittance of light in a first wavelength range to be greater than transmittance of light in a second wavelength range in the first pattern, and the second mixture material is configured to increase transmittance of light in the second wavelength range to be greater than transmittance of light in the first wavelength range in the second pattern.
